(19) United States
(12) Patent Application Publication
(10) Pub. No.: US 2017/0342358 A1
(43) Pub. Date: Nov. 30, 2017

(54) Fermentation Container and Method for Producing Hawthorn Fermented Beverage

(71) Applicant: Rhino H Development LLC, Arlington, TX (US)

(72) Inventor: Yuliang CHENG, Zibo (CN)

(73) Assignee: Rhino H Development LLCC

(21) Appl. No.: 15/607,654

(22) Filed: May 29, 2017

(30) Foreign Application Priority Data
May 30, 2016 (CN) 201610369880.9

(51) Int. Cl. C12G 3/02; B05B 1/06; A23L 2/38; C12R 1/01; A23L 2/02

(52) U.S. Cl. CPC C12G 3/02; C12R 1/01; A23L 2/02; A23L 2/382; B05B 1/06

(57) ABSTRACT

A method and system for producing hawthorn fermented beverage where hawthorn fruits are used as the main material to produce a hawthorn fermented beverage with special fermented flavor, rich nutrition, mellow mouth feel and suitable sourness and sweetness, through the processes of fruit sorting, cleaning, juice squeezing, blending, pre-sterilization, alcoholic fermentation, acetic fermentation, lactic acid fermentation, filtration, sterilization and filling. An atomized fermentation technology is adopted for the yeast aerobic proliferation during the alcoholic fermentation phase and for the acetic fermentation phase, so that, as compared with the liquid submerged fermentation methods, the fermentation time of these two stages are shortened by 10-15 hours and 62-100 hours respectively, and the fermentation period is shortened by 3-5 days, which improves the production efficiency of fermentation.

### BACKGROUND

The present invention relates to a method for producing hawthorn fermented beverage and belongs to the food and beverage processing field.

The conventional hawthorn fermented beverages include two main kinds of products, the hawthorn wine and hawthorn vinegar, which are preferred and popularized for the special flavor, rich nutrition and certain health protecting functions. In recent years, the processing technologies of fermented fruits and vegetables developed rapidly, and the range of fermented products expanded day by day. New fermented beverages, including the fermented fruit and vegetable juice produced by using the plant derived lactic acid bacteria, are introduced to the market in addition to the conventional fruit wine and fruit vinegar. Moreover, the fermentation technologies have been developed into the current popular submerged fermentation and solid-liquid mixed fermentation from the conventional solid or semi-solid fermentation, and the whole production efficiency of fermentation have been improved with shorter production periods and lower production costs.

For having high quantity of organic acids, such as citric acid, malic acid and tartaric acid: flavonoid, such as quercetin; and other nutrition, such as some vitamins, hawthorn fruits are considered having certain health protecting functions, such as improving digestion, reducing blood fat and protecting heart. The fresh hawthorn fruits, however, are too acerbic to eat directly, so that the hawthorn fruits are often made into candied fruits, preserved fruits, juice, vinegar and other fermented products. In addition to the developed technologies, improved quality and considerable added values, the fermented products of hawthorn fruits not only preserve all or part of the original nutrition but also introduce the special flavor and nutritious metabolites of fermentation, which makes such products very popular on the market.

At present, most hawthorn fermented beverages available on the market are hawthorn wine, vinegar and lactic acid bacteria fermented hawthorn juice which are mainly produced based on the solid, solid-liquid and submerged fermentation technologies. Wherein, the solid fermentation has the advantages of rich metabolites and strong flavor, bat needs long fermentation period; the submerged fermentation has high productivity and short fermentation period, but is lacking in metabolites and flavors; and the solid-liquid mixed fermentation is considered as a balanced and compromised option, but needs high levels of fermentation and technologies in addition to the difficulties in determining critical points and the unfavorable productivity of fermentation.

### SUMMARY

In one embodiment a method of phased fermentation of a hawthorn juice in a fermentation container having a pressurized atomization nozzle comprises at least one of injecting the hawthorn juice with an activated fruit wine yeast through the pressurized atomization nozzle to perform atomized fermentation for between approximately 5 and 10 hours at between approximately 20 to 30° C, shutting off a sterile compressed air to the fermentation container for approximately 48 to 96 hours at between approximately 20 to 30° C. to promote anaerobic alcoholic fermentation to yield an alcoholic fermentation liquor, injecting the alcoholic fermentation liquor with activated acetic acid bacteria through the pressurized atomization nozzle to perform atomized fermentation for between approximately 10 and 20 hours at between approximately 25 to 35° C. and shutting off the sterile compressed air to the fermentation container to yield an acetic acid fermentation liquor, injecting the acetic acid fermentation liquor with lactic acid bacteria and shutting off the sterile compressed air to the fermentation container for between approximately 5 and 15 hours at between approximately 35 to 45° C. to yield a lactic acid fermentation liquor.

In another embodiment a fermentation container, having at least one of a container body, a pressurized atomization nozzle located at an inner upper part of the container body, an inlet of sterile compressed air connected to the pressurized atomization nozzle, a sterile breathing apparatus located at an outer upper part of the container body, a fermentation liquor supplying pipe having an outlet connected to the pressurized atomization nozzle and a pump connected to an inlet of the fermentation liquor supplying pipe and to the container body.

### BRIEF DESCRIPTION OF THE DRAWINGS

FIG. 1 depicts a diagram for the simplified configuration of a fermentation container with a pressurized atomization nozzle, wherein: 1—cooling/heating medium inlet; 2—inclined bottom plate, 3—jacket; 4—container body; 5—cooling/heating medium outlet; 6—pressurized atomization nozzle; 7—sterile compressed air inlet; 8—sterile breathing apparatus; 9—fermentation liquor supplying pipe; 10—pump; and 11—discharging opening.

### DETAILED DESCRIPTION OF THE INVENTION

The present invention discloses a method for producing hawthorn fermented beverage, which comprises the processes of hawthorn fruit sorting, cleaning, juice squeezing, blending and pre-sterilization for preparing hawthorn juice; the following processes of alcoholic fermentation, acetic acid fermentation and lactic acid fermentation performed in turn by injecting fruit wine yeast, acetic acid bacteria and lactic acid bacteria in sequence for obtaining hawthorn fermentation liquor; and the subsequent processes of filtration, sterilization and filling to produce a hawthorn fermented beverage.

The present invention discloses a method for producing hawthorn fermented beverage, which comprises the processes of hawthorn fruit sorting, cleaning, juice squeezing, blending and pre-sterilization for preparing hawthorn juice; the following processes of alcoholic fermentation, acetic acid fermentation and lactic acid fermentation performed in turn by injecting fruit wine yeast, acetic acid bacteria and lactic acid bacteria in sequence for obtaining hawthorn fermentation liquor; and the subsequent processes of filtration, sterilization and filling to produce a hawthorn fermented beverage.

Wherein, the fermentations are performed in a fermentation container equipped with a pressurized atomization nozzle; the alcoholic fermentation refers to the procedures of injecting the prepared hawthorn juice with the activated fruit wine yeast, followed by stirring and mixing adequately and uniformly, performing atomized fermentation for 5 to 10 hours with the container temperature kept at 20 to 30° C., and then performing anaerobic fermentation for 48 to 96 hours with the container temperature kept at 20 to 30° C. after shutting off sterile compressed air to obtain the alcoholic fermentation liquor; the acetic acid fermentation refers to the procedures of injecting the alcoholic fermentation liquor with the activated acetic acid bacteria, followed by stirring and mixing adequately and uniformly, performing atomized fermentation for 10 to 20 hours with the container temperature kept at 25 to 35° C., and then shutting off sterile compressed air to obtain the acetic acid fermentation liquor.

In one specific embodiment of this invention, the atomized fermentation is performed by adequately mixing the 0.2 to 0.8 MPa sterile compressed air with the fermentation liquor in the inner mixing chamber of the fermentation container equipped with a pressurized atomization nozzle and then atomizing the mixed sterile compressed air and fermentation liquor by using the pressurized atomization nozzle; during the atomized fermentation, the yeast and acetic acid bacteria can efficiently utilize the oxygen and nutrition of fermentation liquor throughout the extensively expanded air-liquid interface to realize the rapid aerobic proliferation.

In one specific embodiment of this invention, the fermentation container equipped with a pressurized atomization nozzle mainly comprises a container body, a sterile compressed air inlet, a pressurized atomization nozzle, a sterile breathing apparatus, a pump and a fermentation liquor supplying pipe; the pressurized atomization nozzle is arranged at the inner upper part of the container body and connected to the inlet of sterile compressed air and the outlet of fermentation liquor supplying pipe.

The technical solution disclosed in this invention specifically comprises:
(1) Sorting: select hawthorn fruits;
(2) Cleaning: wash hawthorn fruits and drain off;
(3) Squeezing: squeeze hawthorn fruits, remove dregs from pulp through centrifugation, and obtain hawthorn juice after filtration by using gauze;
(4) Blending: adjust the hawthorn juice to a sugar degree of 8 to 18% with pH value at 3.5 to 4.5;
(5) Pre-sterilization: put the hawthorn juice in a water bath at 60 to 90° C. for 20 to 60 min for sterilizing, and then pump the hawthorn juice into a sterilized fermentation container equipped with a pressurized atomization nozzle;
(6) Alcoholic fermentation: inject the blended hawthorn juice with a 2 to 5% seed solution of activated fruit wine yeast, followed by stirring and mixing adequately and uniformly, perform the atomized fermentation for 5 to 10 hours with the container temperature kept at 20 to 30° C. and then perform the anaerobic fermentation for 4 to 96 hours with the container temperature kept at 20 to 30° C. after shutting off sterile compressed air to obtain the alcoholic fomentation liquor;
(7) Acetic acid fermentation: inject the alcoholic fermentation liquor with a 5 to 10% seed solution of activated acetic acid bacteria, followed by stirring and mixing adequately and uniformly, perform the atomized fermentation for 10 to 20 hours with the container temperature kept at 25 to 35° C. and then shut off sterile compressed air to obtain the acetic acid fermentation liquor;
(8) Lactic acid fermentation: inject the acetic acid fermentation liquor (blended and adjusted to a sugar degree of 10 to 15% and a pH value of 5 to 6) with a 2 to 5% seed solution of activated lactic acid bacteria, followed by stirring and mixing adequately and uniformly, and perform the anaerobic fermentation for 5 to 15 hours with the container temperature kept at 35 to 45° C. to obtain the hawthorn fermentation liquor;
(9) Filtration, sterilization and filling: adopt a sterile process to fill the hawthorn fermentation liquor after filtered and sterilized into proper packs to obtain the hawthorn fermented beverage.

In one specific embodiment of this invention, the squeezing as described in Step (3) is conducted to a mixture of hawthorn fruits and, water in a proportion of 1:1 to 1:6.

In one specific embodiment of this invention, the blending as described in Step (4) is performed by using cane sugar to adjust the sugar degree, and using citric acid and sodium carbonate to adjust the pH value.

In one specific embodiment of this invention, the seed solutions as described in Steps (6), (7) and (8) are obtained through the spreading cultivation of second stage seeds after the activation of yeast, acetic acid bacteria or lactic acid bacteria by using slant liquid culture medium.

In one specific embodiment of this invention, the method specifically comprises:
(1) Sorting: select plump hawthorn fruits without any insect damage or mildew or deterioration;
(2) Cleaning: rinse the hawthorn fruits with sufficient fresh water to remove dust, sand and other solid impurities, then rest to drain off the water;
(3) Squeezing: squeeze hawthorn fruits mixed with water in a proportion of 1:1 to 1:6, remove dregs from pulp through centrifugation, and obtain hawthorn juice after filtration by using 60 to 120 mesh gauze;
(4) Blending: use cane sugar to adjust the hawthorn juice to a sugar degree of 8 to 18%, and use citric acid to adjust the hawthorn juice to a pH value of 3.5 to 4.5;
(5) Pre-sterilization: put the hawthorn juice in a water bath at 60 to 90° C. for 20 to 60 min for sterilizing, and then pump the hawthorn juice into a sterilized fermentation container equipped with a pressurized atomization nozzle;
(6) Alcoholic fermentation: activate fruit wine yeast by using slant and liquid culture media, prepare a seed solution after the spreading cultivation of the second stage seeds, inject the blended fermentation liquor with a 2 to 5% seed solution, followed by stirring and mixing adequately and uniformly, perform the atomized fermentation for 5 to 10 hours with the container temperature kept at 20 to 30° C. and then perform the anaerobic fermentation for 48 to 96 hours with the container temperature kept at 20 to 30° C. after shutting off sterile compressed air;
(7) Acetic acid fermentation: activate acetic acid bacteria by using slant and liquid culture media, prepare a seed solution after the spreading cultivation of the second stage seeds, inject the alcoholic fermentation liquor with a 5 to 10% seed solution, followed by stirring and mixing adequately and uniformly, perform the atomized fermentation for 10 to 20 hours with the container temperature kept at 25 to 35° C., and then shut off sterile compressed air;
(8) Lactic acid fermentation: activate lactic acid bacteria by using slant and liquid culture media, prepare a seed solution after the spreading cultivation of the second stage seeds, use cane sugar to adjust the acetic acid fermentation liquor to a sugar degree of 10 to 15%, use sodium carbonate to adjust to a pH value of 5 to 6, inject the blended acetic acid fermentation liquor with a 2 to 5% seed solution, followed by stirring and mixing, adequately and uniformly, and perform the anaerobic fermentation for 5 to 15 hours with the container temperature kept at 35 to 45° C.;
(9) Filtration, sterilization and filling; filter the obtained hawthorn fermentation liquor by using a plate-and-frame filter press and a kieselguhr filter in turn, sterilize by using a multi-tubular sterilization machine operating at 115 to 135° C. for 3 to 8 s, and then fill by using a sterile filling machine

In this invention, a phased fermentation technology is adopted for performing the yeast, acetic acid bacteria and lactic acid bacteria fermentation phases successively; an atomized fermentation technology is adopted for the aerobic proliferation during the phase of alcoholic fermentation and for the phase of acetic acid fermentation, to enable the yeast and acetic acid bacteria to efficiently utilize the oxygen and the nutrition of fermentation liquor throughout the extensively expanded air-liquid interface to realize rapid aerobic proliferation and aerobic fermentation, resulting in improved productivity of fermentation and shorter period of fermentation.

The atomized fermentation during the alcoholic fermentation refers to the aerobic proliferation of yeast during the phase of alcoholic fermentation is performed by adequately mixing the 0.2 to 0.8 MPa sterile compressed air with the fermentation liquor in the inner mixing chamber of the fermentation container equipped with a pressurized atomization nozzle and then atomizing the mixed sterile compressed air and fermentation liquor by using the pressurized atomization nozzle for 5 to 10 hours with the container temperature kept at 20 to 30° C.; during the atomized fermentation, the yeast can efficiently utilize the oxygen and the nutrition of fermentation liquor throughout the extensively expanded air-liquid interface to realize the rapid aerobic proliferation.

The atomized fermentation daring acetic acid fermentation refers to the acetic acid fermentation is performed by adequately mixing the 0.2 to 0.8 MPa sterile compressed air with the fermentation liquor in the inner mixing chamber of the fermentation container equipped with a pressurized atomization nozzle and then atomizing the mixed sterile compressed air and fermentation liquor by using the pressurized atomization nozzle for 10 to 20 hours with the container temperature kept at 25 to 35° C.; during the atomized fermentation, the acetic acid bacteria can efficiently utilize the oxygen and the nutrition of fermentation liquor throughout the extensively expanded air-liquid interface to realize the rapid aerobic proliferation and aerobic fermentation.

The present invention also discloses a fermentation container which mainly comprises a container body, an inlet of sterile compressed air, a pressurized atomization nozzle, a sterile breathing apparatus, a pump and a fermentation liquor supplying pipe; the pressurized atomization nozzle is arranged at the inner upper part of the container body and connected to the inlet of sterile compressed air and the outlet of fermentation liquor supplying pipe.

In one specific embodiment of this invention, the pump is arranged at the inlet or middle part of the fermentation liquor supplying pipe, and the inlet of the fermentation liquor supplying pipe is arranged at the lower part of the container body.

In one specific embodiment of this invention, the sterile breathing apparatus is arranged at the upper part of the container body for keeping the pressure balance of the container during the aerobic fermentation.

In one specific embodiment of this invention, one or more than one pressurized atomization nozzle is provided.

In one specific embodiment of this invention, the fermentation container also comprises a jacket, a cooling/heating medium inlet arranged on the lower external surface of container body, and a cooling/heating medium outlet arranged on the upper external surface of container body, for regulating the temperature of fermentation container.

In one specific embodiment of this invention, the fermentation container is provided with an inclined bottom plate inside the container body for the convenience of discharging.

In one specific embodiment of this invention, the fermentation container is also provided with a discharging opening near the lower end of the inclined bottom plate.

The present invention has the advantages and beneficial effects as follows:
1. Adopt the phased fermentation technology based on the fermentation of yeast, acetic acid bacteria and lactic acid bacteria, to introduce new and special flavors and nutrition into the hawthorn fermented beverage.
2. Adopt the atomized fermentation technology for the aerobic proliferation yeast during the phase of alcoholic fermentation and for the phase of acetic acid fermentation, to enable the yeast and acetic acid bacteria to efficiently utilize the oxygen and the nutrition of fermentation liquor throughout the extensively expanded air-liquid interface to realize rapid aerobic proliferation and aerobic fermentation, which considerably shortens the period of fermentation and improves the productivity of fermentation.

### SPECIFIC EMBODIMENT METHODS

### First Embodiment

Select 100 g plump hawthorn fruits without any insect damage or mildew or deterioration. Rinse with sufficient fresh water to remove dust, sand and other solid impurities. Rest to drain off the water. Use a squeezing machine to squeeze the hawthorn fruits mixed with water in a proportion of 1:6. Remove dregs from pulp through centrifugation, and obtain hawthorn juice after filtration by using 60-mesh gauze. Use cane sugar to adjust the sugar degree of hawthorn juice to 8%, and use citric acid to adjust the pH value of hawthorn juice to 4.5. Put the juice into a 90° C. water bath for sterilizing for 20 minutes. Pump the juice into a fermentation container equipped with a pressurized atomization nozzle.

Activate fruit wine yeast by using slant and liquid culture media, prepare a seed solution after the spreading cultivation of the second stage seeds, and inject the blended fermentation liquor with a 5% seed solution, followed by stirring and mixing adequately and uniformly. Introduce 0.2 MPa sterile compressed air to atomize the fermentation liquor through the pressurized atomization nozzle for 10 hours with the container temperature kept at 20° C. to realize the rapid aerobic proliferation of yeast. Then shut off the sterile compressed air, and perform the anaerobic fermentation for 96 hours with the container temperature kept at 20° C. to finish the phase of alcoholic fermentation. Activate acetic acid bacteria by using slant and liquid culture media, prepare a seed solution after the spreading cultivation of the second stage seeds, and inject the alcoholic fermentation liquor with a 5% seed solution, followed by stirring and mixing adequately and uniformly. Introduce 0.8 MPa sterile compressed air to atomize the fermentation liquor through the pressurized atomization nozzle for 20 hours with the container temperature kept at 25° C. Then shut off the sterile compressed air to finish the phase of acetic acid fermentation. Activate lactic acid bacteria by using slant and liquid culture media, prepare a seed solution after the spreading cultivation of the second stage seeds, and inject the blended acetic acid fermentation liquor with a 5% seed solution, followed by stirring and mixing adequately and uniformly. Perform anaerobic fermentation for 5 hours with the container temperature kept at 35° C. to finish the phase of lactic acid fermentation.

Filter the obtained hawthorn fermentation liquor by using a plate-and-frame filter press and a kieselguhr filter in turn, sterilize by using a multi-tubular sterilization machine operating at 135° C. for 3 s, and then fill by using a sterile filling machine into proper packs to obtain the finished products of hawthorn fermented beverage.

### Second Embodiment

Select 200 g plump hawthorn fruits without any insect damage or mildew or deterioration. Rinse with sufficient fresh water to remove dust, sand and other solid impurities. Rest to drain off the water. Use a squeezing machine to squeeze the hawthorn fruits mixed with water in a proportion of 1:1. Remove dregs from pulp through centrifugation, and obtain hawthorn juice after filtration by using 120-mesh gauze. Use cane, sugar to adjust the sugar degree of hawthorn juice to 18%, and use citric acid to adjust the pH value of hawthorn juice to 3.5. Put the juice into a 60° C. water bath for sterilizing for 60 minutes. Pump the juice into a fermentation container equipped with a pressurized atomization nozzle.

Activate fruit wine yeast by using slant and liquid culture media, prepare a seed solution after the spreading cultivation of the second stage seeds, and inject the blended fermentation liquor with a 2% seed solution, followed by stirring and mixing adequately and uniformly. Introduce 0.8 MPa sterile compressed air to atomize the fermentation liquor through the pressurized atomization nozzle for 5 hours with the container temperature kept at 30° C. to realize the rapid aerobic proliferation of yeast. Then shut off the sterile compressed air, and perform the anaerobic fermentation for 48 hours with the container temperature kept at 30° C. to finish the phase of alcoholic fermentation. Activate acetic acid bacteria by using slant and liquid culture media, prepare a seed solution after the spreading cultivation of the second stage seeds, and inject the alcoholic fermentation liquor with a 10% seed solution, followed by stirring and mixing adequately and uniformly. Introduce 0.2 MPa sterile compressed air to atomize the fermentation liquor through the pressurized atomization nozzle for 10 hours with the container temperature kept at 35° C. Then shut off the sterile compressed air to finish the phase of acetic acid fermentation. Activate lactic acid bacteria by using slant and liquid culture media, and prepare a seed solution after the spreading cultivation of the second stage seeds, inject the blended acetic acid fermentation liquor with a 2% seed solution, followed by stirring and mixing adequately and uniformly. Perform anaerobic fermentation for 15 hours with the container temperature kept at 45° C. to finish the phase of lactic acid fermentation.

Filter the obtained hawthorn fermentation liquor by using a plate-and-frame filter press and a kieselguhr filter in turn, sterilize by using a multi-tubular sterilization machine operating at 115° C. for 8 s, and then fill by using a sterile filling machine into proper packs to obtain the finished products of hawthorn fermented beverage.

### Comparative First Embodiment

Adopt liquid fermentation during the aerobic proliferation of yeast in the phase of alcoholic fermentation, namely shut off the pressurized atomization nozzle installed on the fermentation container, as follows:

Activate fruit wine yeast by using slant and liquid culture media, prepare a seed solution after the spreading cultivation of the second stage seeds, inject the blended, fermentation liquor with a 2 to 5% seed solution, followed by stirring and mixing adequately and uniformly. Turn on the sterile breathing apparatus on the fermentation container to introduce sterile compressed air at 70 to 90 L/h for 15 to 25 hours with the container temperature kept at 20 to 30° C. to realize the rapid aerobic proliferation of yeast. Then shut off the sterile breathing apparatus, and perform the anaerobic fermentation for 48 to 96 hours with the container temperature kept at 20 to 30° C. to finish the phase of alcoholic fermentation.

Other procedures are same as the first embodiment.

### Comparative Second Embodiment

Adopt liquid fermentation during the aerobic proliferation of yeast in the phase of acetic acid fermentation, namely shut off the pressurized atomization nozzle installed on the fermentation container, as follows:

Activate acetic acid bacteria by using slant and liquid culture media, prepare a seed solution after the spreading cultivation of the second stage seeds, and inject the alcoholic fermentation liquor with a 5 to 10% seed solution, followed by stirring and mixing adequately and uniformly. Turn on the sterile breathing apparatus on the fermentation container to introduce sterile compressed air at 70 to 90 L/h for 72 to 120 hours with the container temperature kept at 25 to 35° C. Then shut off the sterile breathing apparatus to finish the phase of acetic acid fermentation.

Other procedures are same the second embodiment.

In the Embodiments 1 and 2, the atomized fermentation technology is adopted for the aerobic proliferation of yeast during the phase of alcoholic fermentation and for the phase of acetic acid fermentation, so that the fermentation durations are shortened respectively by 10 to 15 hours and 62 to 100 hours as compared with the submerged fermentation methods as described in Comparative Embodiments 1 and 2, and the fermentation period of this invention is shortened by 3 to 5 d as compared with the method of applying liquid fermentation to both aerobic proliferation of yeast and acetic acid fermentation.

Moreover, the hawthorn fermented beverages produced by using the method disclosed by this invention have special fermented flavor, rich nutrition, mellow mouth feel and suitable sourness and sweetness to satisfy the demands of most consumers. According to the results of grouped sensory evaluations, the hawthorn fermented beverages produced by using the method disclosed by this invention are superior to the products made by using the liquid submerged fermentation methods.

### Third Embodiment

### The Fermentation Container Equipped with a Pressurized Atomization Nozzle Disclosed by this Invention

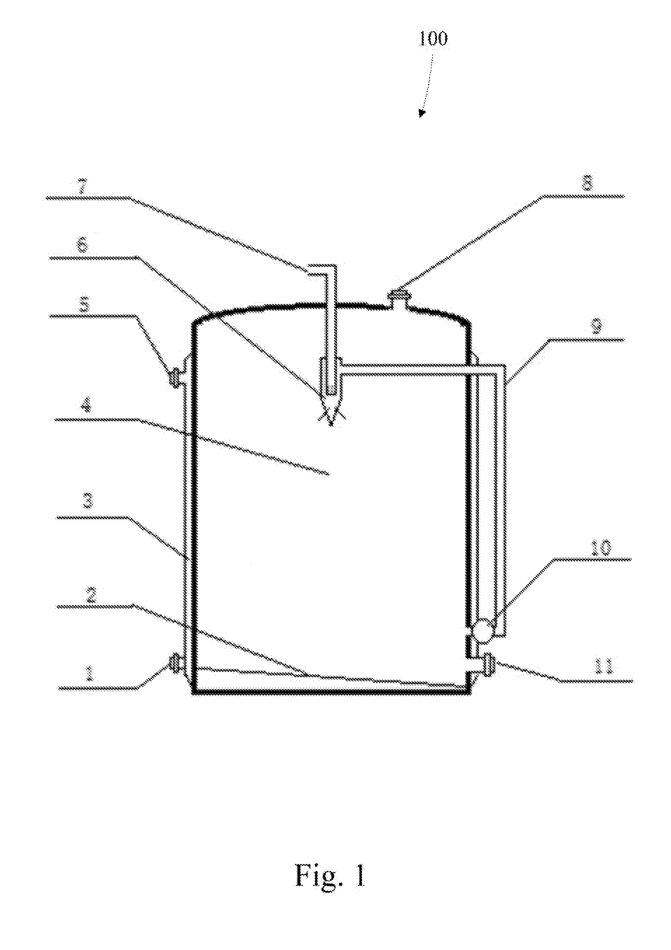

FIG. 1. shows a diagram for the simplified configuration of a fermentation container with a pressurized atomization nozzle.

The fermentation container mainly comprises a container body 4, a sterile compressed air inlet 7, a pressurized atomization nozzle 6, a sterile breathing apparatus 8, a pump 10 and a fermentation liquor supplying pipe 9. The pressurized atomization nozzle 6 is arranged on the upper part of the container body 4 and connected to the sterile compressed air inlet 7 and fermentation liquor supplying pipe 9, to atomize the fermentation liquor from the fermentation liquor supplying pipe.

The pump 10 is arranged at the inlet or middle part of the fermentation liquor supplying pipe 9, and the inlet of the fermentation liquor supplying pipe 9 is arranged at the lower part of the container body 4.

The sterile breathing apparatus 8 is arranged at the upper part of the container body 4 for keeping the pressure balance of the container during the aerobic fermentation.

One or more than one pressurized atomization nozzle 6 is provided.

The fermentation container also comprises a jacket 3, a cooling/heating medium inlet 1 arranged on the lower external surface of container body 4, and a cooling/heating medium outlet 5 arranged on the upper external surface of container body 4, for regulating the temperature of fermentation container.

In one specific embodiment of this invention, the fermentation container is provided with an inclined bottom plate 2 inside the container body for the convenience of discharging.

In one specific embodiment of this invention, the fermentation container is also provided with a discharging opening 11 near the lower end of the inclined bottom plate 2.

Embodiments of the present disclosure may take on various modifications and alterations without departing from the spirit and scope of the disclosure. Accordingly, it is to be understood that the embodiments of the present disclosure are not to be limited to the described exemplary embodiments, but are to be controlled by the limitations set forth in the claims and any equivalents thereof.

What is claimed is:

1. A method of phased fermentation of a hawthorn juice in a fermentation container having a pressurized atomization nozzle, comprising:
injecting the hawthorn juice with an activated fruit wine yeast through the pressurized atomization nozzle to perform atomized fermentation for between approximately 5 and 10 hours at between approximately 20 to 30° C.;
shutting off a sterile compressed air to the fermentation container for approximately 48 to 96 hours at between approximately 20 to 30° C. to promote anaerobic alcoholic fermentation to yield an alcoholic fermentation liquor;
injecting the alcoholic fermentation liquor with activated acetic acid bacteria through the pressurized atomization nozzle to perform atomized fermentation for between approximately 10 and 20 hours at between approximately 25 to 35° C.; and
shutting oil the sterile compressed air to the fermentation container to yield an acetic acid fermentation liquor;
injecting the acetic acid fermentation liquor with lactic acid bacteria; and
shutting off the sterile compressed air to the fermentation container for between approximately 5 and 15 hours at between approximately 35 to 45° C. to yield a lactic acid fermentation liquor.

2. The method of phased fermentation of claim 1, wherein the atomized fermentation is performed utilizing by adequately mixing the approximately 0.2 to 0.8 MPa sterile compressed air with the fermentation liquor in an inner mixing chamber of the fermentation container equipped with the pressurized atomization nozzle and then atomizing a mixture of the sterile compressed air and the fermentation liquor by using the pressurized atomization nozzle.

3. The method of phased fermentation of claim 1, the fermentation container equipped with the pressurized atomization nozzle further comprising:
a container body;
an inlet of sterile compressed air connected to the pressurized atomization nozzle;
a sterile breathing apparatus located at an outer upper part of the container body;
a fermentation liquor supplying pipe having a fermentation liquor supplying pipe outlet connected to the pressurized atomization nozzle; and
a pump connected to an inlet of the fermentation liquor supplying pipe and to the container body; and
wherein the pressurized atomization nozzle located at an inner upper part of the container body.

4. The method of phased fermentation of claim 1, further comprising
sorting a hawthorn fruit;
washing the sorted hawthorn fruit;
squeezing the washed hawthorn fruit;
centrifuging squeezed hawthorn fruit;
filtering the centrifuged hawthorn fruit using gauze to produce filtered hawthorn juice;
blending the filtered hawthorn juice to a sugar degree of 8 to 18% with pH value at 3.5 to 4.5;
pre-sterilizing the blended hawthorn juice in a water bath at 60 to 90° C., for 20 to 60 min;
pumping the pre-sterilized hawthorn juice into a sterilized fermentation container equipped with the pressurized atomization nozzle;
injecting the blended hawthorn juice with a 2 to 5% seed solution of activated fruit wine yeast to promote alcoholic fermentation;
stirring and mixing the activated fruit wine yeast injected hawthorn juice;
performing atomized fermentation for 5 to 10 hours at 20 to 30° C.;
anaerobically fermenting for 48 to 96 hours at 20 to 30° C. after shutting off sterile compressed air to obtain the alcoholic fermentation liquor;
injecting the alcoholic fermentation liquor with a 5 to 10% seed solution of activated acetic acid bacteria;
stirring and mixing the activated acetic acid bacteria injected liquor;
performing atomized fermentation for 10 to 20 hours at 25 to 35° C.;
anaerobically fermenting the activated acetic acid bacteria injected liquor of shutting off sterile compressed air to obtain the acetic acid fermentation liquor;
injecting the acetic acid fermentation liquor with a 2 to 5% seed solution of activated lactic acid bacteria;
stirring and mixing the lactic acid bacteria injected fermentation liquor;
anaerobically fermenting for 5 to 15 hours at 35 to 45° C. to obtain a hawthorn fermentation liquor;
filtering the hawthorn fermentation liquor;
sterilizing the filtered hawthorn fermentation liquor; and
filling the sterilized hawthorn fermentation liquor to obtain a hawthorn fermented beverage.

5. The method of phased fermentation of claim 4, wherein the squeezing is conducted on a mixture of hawthorn fruits and water in a proportion of 1:1 to 1:6.

6. The method of phased fermentation of claim 4, wherein the blending is performed by using cane sugar to adjust the sugar degree, and using citric acid and sodium carbonate to adjust the pH value.

7. The method of phased fermentation of claim 1, further comprising:
sorting a hawthorn fruit to discard insect damaged, mildewed and deteriorated fruit washing the sorted hawthorn fruit with water to remove dust, sand, and other impurities, then rest to drain off the water;
squeezing the washed hawthorn fruit mixed with water in a proportion of 1:1 to 1:6;
centrifuging the squeezed hawthorn fruit;
filtering the centrifuged hawthorn fruit to obtain a filtered hawthorn juice after filtration by using, 60 to 120 mesh gauze;
blending the filtered hawthorn juice using cane sugar to adjust the hawthorn juice to a sugar degree of 8 to 18%, and use citric acid to adjust the hawthorn juice to a pH value of 3.5 to 4.5;
pre-sterilizing the blended hawthorn juice in a water bath at 60 to 90° C. for 20 to 60 minutes;
pumping the pre-sterilized hawthorn juice into a sterilized fermentation container equipped with the pressurized atomization nozzle;
activating fruit wine yeast by using slant and liquid culture media;
preparing a fruit wine yeast seed solution after a spreading cultivation of a fruit wine yeast second stage seeds;
injecting a blended fermentation liquor with a 2 to 5% fruit wine yeast seed solution;
stirring, and mixing the blended fermentation liquor;
performing atomized fermentation for 5 to 10 hours at 20 to 30° C.;
anaerobically fermenting for 48 to 96 hours at 20 to 30° C. after shutting off sterile compressed air;
activating acetic acid bacteria by using slant and liquid culture media;
preparing an acetic acid bacteria seed solution after the spreading cultivation of an acetic acid bacteria second stage seeds;
injecting the alcoholic fermentation liquor with a 5 to 10% acetic acid bacteria seed solution;
stilling and mixing the alcoholic fermentation liquor;
performing atomized fermentation for 10 to 20 hours at 25 to 35° C., and then shut off sterile compressed air;
activating lactic acid bacteria by using slant and liquid culture media,
preparing a lactic acid bacteria seed solution after the spreading cultivation of a lactic acid bacteria second stage seeds, use cane sugar to adjust the acetic acid fermentation liquor to a sugar degree of 10 to 15%, use sodium carbonate to adjust to a pH value of 5 to 6,
injecting a blended acetic acid fermentation liquor with a 2 to 5% lactic acid bacteria seed solution,
stirring and mixing the blended acetic acid fermentation liquor:
anaerobically fermenting for 5 to 15 hours at 35 to 45° C. the blended acetic acid fermentation liquor to obtain a hawthorn fermentation liquor;
filtering the hawthorn fermentation liquor by using a plate-and-frame filter press and a kieselguhr filter in turn;
sterilizing the hawthorn fermentation liquor by using a multi-tubular sterilization machine operating at 115 to 135° C. for 3 to 8 seconds; and
filling by using a sterile filling machine.

8. A fermentation container, comprising:
a container body;
a pressurized atomization nozzle located at an inner upper part of the container body;
an inlet of sterile compressed air connected to the pressurized atomization nozzle;
a sterile breathing apparatus located at an outer upper part of the container body;
a fermentation liquor supplying pipe having an outlet connected to the pressurized atomization nozzle; and
a pump connected to an inlet of the fermentation liquor supplying pipe and to the container body.

9. The fermentation container of claim 8, further comprising one or more pressurized atomization nozzles.

10. The fermentation container of claim 8, wherein the fermentation container is utilized for fermentation.

11. The fermentation container of claim 9, wherein the fermentation container is utilized for fermentation.
